(19) United States
(12) Patent Application Publication
(10) Pub. No.: US 2026/0238497 A1
(43) Pub. Date: Aug. 13, 2026

(54) SERVICE EXECUTION METHOD AND APPARATUS, STORAGE MEDIUM, AND ELECTRONIC DEVICE

(71) Applicant: Alipay (Hangzhou) Digital Service Technology Co., Ltd., Hangzhou (CN)

(72) Inventors: Wanqiao ZHANG, Hangzhou (CN); Lin HUANG, Hangzhou (CN); Wenjie LI, Hangzhou (CN)

(21) Appl. No.: 19/639,047

(22) Filed: Apr. 3, 2026

Related U.S. Application Data
(63) Continuation of application No. PCT/CN2024/123030, filed on Sep. 30, 2024.

(30) Foreign Application Priority Data
Oct. 8, 2023 (CN) 202311295450.3

(51) Int. Cl. H04L 9/32; H04L 9/08; H04L 9/30

(52) U.S. Cl. CPC H04L 9/3263; H04L 9/0822; H04L 9/0825; H04L 9/30; H04L 9/321

(57) ABSTRACT

The present specification discloses a service execution method and apparatus, a storage medium, and an electronic device. The service execution method includes: A client sends an information acquisition request for a third-party service provider to a server corresponding to the client, so that the server sends pre-stored first verification information corresponding to the third-party service provider to the client. The first verification information is generated by the server based on a digital certificate of the third-party service provider after a trust relationship is established between a service party corresponding to the server and the third-party service provider. A verification request used to verify service compliance of the third-party service provider is sent to the third-party service provider, so that the third-party service provider sends the digital certificate to the client. Second verification information corresponding to the third-party service provider is generated based on the received digital certificate. Service compliance verification is performed on the third-party service provider based on the first verification information and the second verification information, and a target service is executed based on a verification result.

### TECHNICAL FIELD

The present specification relates to the field of Internet technologies, and in particular, to a service execution method and apparatus, a storage medium, and an electronic device.

### BACKGROUND

With rapid development of Internet technologies, users also face greater challenges to privacy and property security in various internet based activities. When the user execute a service by using an application client, because a server of the client usually supports only some basic services, a third-party platform (for example, a mini program) deployed in the client by a third-party service provider serves as an access entry for a service that is not supported by the server.

In a data transmission process, data is usually encrypted through homomorphic encryption, secure multi-party computation, etc., to avoid data leakage.

To further ensure security of a service platform, authenticity and security of the third-party service provider is further verified to ensure that a potential data security risk can be avoided radically. However, in existing solutions, when the client accesses the third-party platform, a digital certificate sent by the third-party service provider is usually forwarded to a certificate authority, and the certificate authority verifies the third-party service provider and delivers a verification result to the client. The verification result is easily tampered with by a malicious user when being transmitted by the certificate authority to the client, so that the user executes a service on an untrusted service platform, which seriously affects privacy and property security of the user.

### SUMMARY

The present specification provides technical solutions that, among others, effectively avoid a risk of disclosing and tampering with the verification result of the third-party service provider and improve privacy and property security of the users.

The present specification provides a service execution method and apparatus, a storage medium, and an electronic device, which can verify, on a client, security and validity of a digital certificate of a third-party service provider.

The following technical solution is used in the present specification: sending, by a client, an information acquisition request for a third-party service provider to a server corresponding to the client, so that the server sends pre-stored first verification information corresponding to the third-party service provider to the client based on the information acquisition request, the first verification information being generated by the server based on a digital certificate of the third-party service provider after a trust relationship is established between a service party corresponding to the server and the third-party service provider; sending, to the third-party service provider, a verification request used to verify service compliance of the third-party service provider, so that the third-party service provider sends the digital certificate of the third-party service provider to the client based on the verification request; generating second verification information corresponding to the third-party service provider based on the received digital certificate; and performing service compliance verification on the third-party service provider based on the first verification information and the second verification information, and executing a target service based on a verification result obtained through the service compliance verification.

For example, the method further includes: before the performing the service compliance verification on the third-party service provider based on the first verification information and the second verification information, storing the obtained first verification information in a secure environment provided on a terminal device on which the client is installed, where the secure environment includes a trusted execution environment (TEE), where the generating the second verification information corresponding to the third-party service provider based on the received digital certificate includes: transmitting the received digital certificate to the secure environment, to generate the second verification information corresponding to the third-party service provider in the secure environment; and the performing the service compliance verification on the third-party service provider based on the first verification information and the second verification information includes: performing the service compliance verification on the third-party service provider based on the first verification information and the second verification information in the secure environment.

For example, the sending, to the third-party service provider, the verification request used to verify the service compliance of the third-party service provider, so that the third-party service provider sends the digital certificate of the third-party service provider to the client based on the verification request includes: sending the information acquisition request to the server, so that the server encrypts the first verification information by using a predetermined first public key, to obtain encrypted first verification information; and decrypting the encrypted first verification information by using a first private key pre-stored on a terminal device on which the client is installed, to obtain the first verification information.

For example, the executing the target service based on the verification result obtained through the service compliance verification includes: encrypting a predetermined communication key by using a locally pre-stored second private key, to obtain an encrypted communication key, where the second private key is generated by the server based on client information of the client and sent to the client; and sending the encrypted communication key to the third-party service provider, so that the third-party service provider decrypts the encrypted communication key by using a locally pre-stored second public key corresponding to the second private key, to obtain the communication key, and after identifying service data corresponding to a service request sent by the client, encrypts the service data by using the communication key, to send encrypted service data to the client, where the second public key is generated by the server based on the client information and sent to the third-party service provider.

For example, the method further includes: receiving a data acquisition request sent by the third-party service provider for specified data; generating third verification information based on the first verification information obtained and a locally pre-stored second private key, where the second private key is generated by the server based on client information of the client and sent to the client; and sending the third verification information and the specified data to the third-party service provider, so that the third-party service provider generates fourth verification information based on a received second public key and a digital certificate locally pre-stored at the third-party service provider, verifies a data source of the specified data based on the third verification information and the fourth verification information, and executes a service based on the specified data after verifying the data source succeeds, where the second public key is generated by the server based on the client information and sent to the third-party service provider.

The present specification provides a service execution method, including: receiving, by a third-party service provider, a verification request sent by a client to verify service compliance of the third-party service provider, the verification request being sent by the client to the third-party service provider after receiving first verification information corresponding to the third-party service provider, the first verification information being sent by a server corresponding to the client to the client after receiving an information acquisition request sent by the client, and the first verification information being generated by the server based on a digital certificate of the third-party service provider after a trust relationship is established between a service party corresponding to the server and the third-party service provider; and sending the digital certificate of the third-party service provider to the client based on the verification request, so that the client generates second verification information corresponding to the third-party service provider based on the received digital certificate, verifies the third-party service provider based on the first verification information and the second verification information, and executes a target service based on a verification result obtained through the service compliance verification.

For example, the method further includes: sending a data acquisition request for specified data to the client, so that the client generates third verification information based on the first verification information obtained and a locally pre-stored second private key, and sends the third verification information and the specified data to the third-party service provider, where the second private key is generated by the server based on client information of the client and sent to the client; generating fourth verification information based on a received second public key and a digital certificate locally pre-stored at the third-party service provider, where the second public key is generated by the server based on the client information and sent to the third-party service provider; and verifying a data source of the specified data based on the third verification information and the fourth verification information, and executing a service based on the specified data after verifying the data source succeeds.

The present specification provides a service execution apparatus, including: an acquisition module, configured to send an information acquisition request for a third-party service provider to a server corresponding to a client, so that the server sends pre-stored first verification information corresponding to the third-party service provider to the client based on the information acquisition request, the first verification information being generated by the server based on a digital certificate of the third-party service provider after a trust relationship is established between a service party corresponding to the server and the third-party service provider; a sending module, configured to send, to the third-party service provider, a verification request used to verify service compliance of the third-party service provider, so that the third-party service provider sends the digital certificate of the third-party service provider to the client based on the verification request; a generation module, configured to generate second verification information corresponding to the third-party service provider based on the received digital certificate; and a verification module, configured to: perform service compliance verification on the third-party service provider based on the first verification information and the second verification information, and execute a target service based on a verification result obtained through the service compliance verification.

For example, before service compliance verification is performed on the third-party service provider based on the first verification information and the second verification information, the acquisition module is further configured to store the obtained first verification information in a secure environment provided on a terminal device on which the client is installed, where the secure environment includes a trusted execution environment (TEE); the generation module is configured to transmit the received digital certificate to the secure environment, to generate the second verification information corresponding to the third-party service provider in the secure environment; and the verification module is configured to perform the service compliance verification on the third-party service provider based on the first verification information and the second verification information in the secure environment.

For example, the sending module is configured to: send the information acquisition request to the server, so that the server encrypts the first verification information by using a predetermined first public key, to obtain encrypted first verification information; and decrypt the encrypted first verification information by using a first private key pre-stored on a terminal device on which the client is installed, to obtain the first verification information.

For example, the verification module is configured to: encrypt a predetermined communication key by using a locally pre-stored second private key, to obtain an encrypted communication key, where the second private key is generated by the server based on client information of the client and sent to the client; and send the encrypted communication key to the third-party service provider, so that the third-party service provider decrypts the encrypted communication key by using a locally pre-stored second public key corresponding to the second private key, to obtain the communication key, and after identifying service data corresponding to a service request sent by the client, encrypts the service data by using the communication key, to send encrypted service data to the client, where the second public key is generated by the server based on the client information and sent to the third-party service provider.

For example, the verification module is further configured to: receive a data acquisition request sent by the third-party service provider for specified data; generate third verification information based on the first verification information obtained and a locally pre-stored second private key, where the second private key is generated by the server based on client information of the client and sent to the client; and send the third verification information and the specified data to the third-party service provider, so that the third-party service provider generates fourth verification information based on a received second public key and a digital certificate locally pre-stored at the third-party service provider, verifies a data source of the specified data based on the third verification information and the fourth verification information, and executes a service based on the specified data after verifying the data source succeeds, where the second public key is generated by the server based on the client information and sent to the third-party service provider.

The present specification provides a service execution apparatus, including: a receiving module, configured to receive, by a third-party service provider, a verification request sent by a client to verify service compliance of the third-party service provider, the verification request being sent by the client to the third-party service provider after receiving first verification information corresponding to the third-party service provider, the first verification information being sent by a server corresponding to the client to the client after receiving an information acquisition request sent by the client, and the first verification information being generated by the server based on a digital certificate of the third-party service provider after a trust relationship is established between a service party corresponding to the server and the third-party service provider; and a verification module, configured to send the digital certificate of the third-party service provider to the client based on the verification request, so that the client generates second verification information corresponding to the third-party service provider based on the received digital certificate, verifies the third-party service provider based on the first verification information and the second verification information, and executes a target service based on a verification result obtained through the service compliance verification.

For example, the verification module is further configured to: send a data acquisition request for specified data to the client, so that the client generates third verification information based on the first verification information obtained and a locally pre-stored second private key, and sends the third verification information and the specified data to the third-party service provider, where the second private key is generated by the server based on client information of the client and sent to the client; generate fourth verification information based on a received second public key and a digital certificate locally pre-stored at the third-party service provider, where the second public key is generated by the server based on the client information and sent to the third-party service provider; and verify a data source of the specified data based on the third verification information and the fourth verification information, and execute a service based on the specified data after verifying the data source succeeds.

The present specification provides a computer-readable storage medium. The storage medium stores a computer program, and when the computer program is executed by a processor, the service execution method is implemented.

The present specification provides an electronic device, including a storage, a processor, and a computer program that is stored in the storage and that can run on the processor. When the processor executes the program, the service execution method is implemented.

The at least one technical solution used in the present specification can achieve the following beneficial effects: In the service execution method provided in the present specification, a client sends an information acquisition request for a third-party service provider to a server corresponding to the client, so that the server sends pre-stored first verification information corresponding to the third-party service provider to the client. The first verification information is generated by the server based on a digital certificate of the third-party service provider after a trust relationship is established between a service party corresponding to the server and the third-party service provider. A verification request used to verify service compliance of the third-party service provider is sent to the third-party service provider, so that the third-party service provider sends the digital certificate to the client. Second verification information corresponding to the third-party service provider is generated based on the received digital certificate. Service compliance verification is performed on the third-party service provider based on the first verification information and the second verification information, and a target service is executed based on a verification result.

It can be learned from the above method that, in this solution, in a process of verifying the service compliance of the third-party service provider, the client can verify the digital certificate of the third-party service provider based on verification information delivered by a trusted server to the client. Compared with a current manner in which a certificate authority verifies the third-party service provider and delivers a verification result to the client, in this solution, a risk that the verification result is tampered with by a malicious user in a transmission process can be avoided, thereby ensuring privacy and property security of a user.

### BRIEF DESCRIPTION OF DRAWINGS

The accompanying drawings described herein are used to provide further understanding of the present specification and constitute a part of the present specification. The example implementations of the present specification and descriptions of the implementations are used to explain the present specification, and do not constitute an undue limitation on the present specification. In the accompanying drawings:

FIG. 1 is a schematic flowchart illustrating a service execution method according to the present specification;

FIG. 2 is a schematic diagram illustrating a verification process between a client and a third-party service provider according to the present specification;

FIG. 3 is a schematic diagram illustrating a process in which a third-party service provider verifies a data source according to the present specification;

FIG. 4 is a schematic flowchart illustrating a service execution method according to the present specification;

FIG. 5 is a schematic diagram illustrating a service execution apparatus according to the present specification;

FIG. 6 is a schematic diagram illustrating a service execution apparatus according to the present specification; and

FIG. 7 is a schematic diagram illustrating an electronic device corresponding to FIG. 1 or FIG. 4 according to the present specification.

### DESCRIPTION OF EMBODIMENTS

To make the technical features, technical solutions, and improvements of the present specification clearer, the following clearly and comprehensively describes the example technical solutions in the present specification with reference to example implementations of the present specification and corresponding accompanying drawings. Clearly, the described implementations are merely some rather than all of the implementations of the present specification. All other implementations obtained by those of ordinary skill in the art based on the implementations of the present specification without innovative efforts fall within the protection scope of the present specification.

The technical solutions provided in the implementations of the present specification are described in detail below with reference to the accompanying drawings.

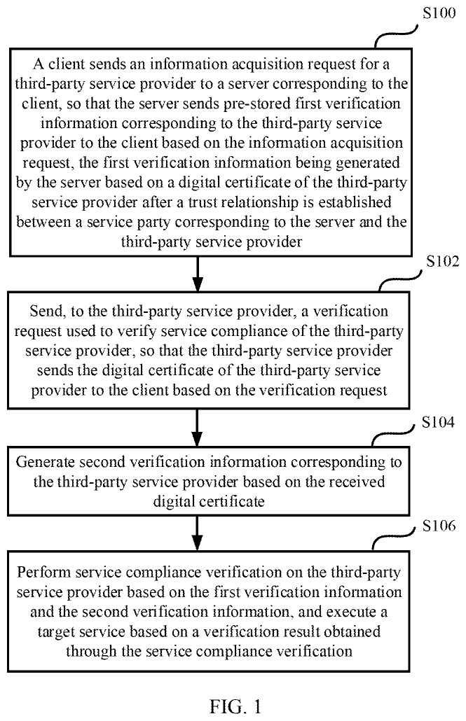

FIG. 1 is a schematic flowchart illustrating a service execution method according to the present specification. The method includes step S100 to step S106.

S100: A client sends an information acquisition request for a third-party entity, e.g., a service provider, to a server corresponding to the client, so that the server sends pre-stored first verification information corresponding to the third-party service provider to the client based on the information acquisition request, the first verification information being generated by the server based on a digital certificate of the third-party service provider after a trust relationship is established between a service party corresponding to the server and the third-party service provider.

A super application (APP) usually integrates a plurality of third-party service functions, and has the relatively large number of users. Before the user executes a service such as a transaction, a deposit, a loan, and a security transaction by using the super app, the client usually verifies service compliance of a service provider of a third-party service, to avoid a case in which the third-party service provider executes an abnormal service and consequently, a certificate expires, a certificate is tampered with, the user accesses a fake page, or the like, thereby ensuring service security.

For example, when the user executes the security transaction by using a client of a transaction platform, service compliance of the third-party (for example, a mini program of a security firm platform) service provider is verified before the user is allowed to execute the security transaction by using the client, to avoid infringement on privacy and property security of the user.

To ensure reliability of a verification result of the third-party service provider, the present specification provides a service execution method. The service compliance of the third-party service provider is verified in a local trusted execution environment of the client, thereby avoiding a risk of tampering with the verification result by a malicious user in a transmission process.

Before the client verifies the service compliance of the third-party service provider, a group of public key and private key can be predetermined on a privacy computing platform, including a first private key and a first public key. The privacy computing platform can send the first private key to the client, store the first private key in a secure environment provided on a terminal device on which the client is installed, and send the first public key to a server associated with the client. The service compliance can be authenticity and security of the third-party service provider.

The terminal device can be a specified device such as a mobile phone, a tablet computer, a notebook computer, and a desktop computer, and the server can be a first-party server that belongs to the same manufacturer as the client and that is specifically configured to execute a service function corresponding to the client. In other words, there is a mutual trust relationship between the server and the client.

When the user accesses a third-party page by using the client, the client can first send the information acquisition request to the server. The information acquisition request can be an initial certificate request that carries device information corresponding to the terminal device. After receiving the information acquisition request, the server can send first verification information of a third-party service provider corresponding to the third-party page to the client.

After obtaining the first verification information, the client can store the first verification information in the secure environment provided on the terminal device.

Further, the server can further generate a pair of public key and private key based on a software development kit (SDK) of the client, including a second private key and a second public key. The server can send the second private key to the client, store the second private key in a trusted environment of the terminal device, and send the second public key to the third-party service provider.

It should be noted that after the trust relationship (for example, both parties performs subscription) is established between the service party corresponding to the server and the third-party service provider, the server can obtain the digital certificate corresponding to the third-party service provider and send the second public key to the third-party service provider, and then the server can calculate a hash value of the digital certificate to generate a digest of key information, and store the hash value of the digital certificate as the first verification information.

In the present specification, the digital certificate of the third-party service provider can be a certificate authority (CA) certificate delivered by a CA to the third-party service provider, and can include one or more of a website certificate, an intermediate certificate, and a root certificate.

In addition, the secure environment mentioned in the present specification can be a trusted execution environment (TEE) provided on the terminal device, or certainly, can be another secure environment. This is not specifically limited in the present specification.

In a process in which the server sends the first verification information and the second private key to the client, the server can encrypt the first verification information and the second private key by using the first public key, to obtain encrypted first verification information and an encrypted second private key. After receiving the encrypted first verification information and the encrypted second private key, the client can decrypt the encrypted first verification information and the encrypted second private key in the secure environment by using the pre-stored first private key, to obtain the decrypted first verification information and the decrypted second private key, and store the first verification information and the second private key in the secure environment.

S102: Send, to the third-party service provider, a verification request used to verify service compliance of the third-party service provider, so that the third-party service provider sends the digital certificate of the third-party service provider to the client based on the verification request.

S104: Generate second verification information corresponding to the third-party service provider based on the received digital certificate.

After obtaining the first verification information and the second private key, the client can send, to the third-party service provider, the verification request used to verify the service compliance of the third-party service provider. After receiving the verification request, the third-party service provider can send the digital certificate of the third-party service provider to the client based on the verification request.

After receiving the digital certificate, the client can calculate a hash value corresponding to the digital certificate, use the hash value as the second verification information, and then store the second verification information in the secure environment of the terminal device.

S106: Perform service compliance verification on the third-party service provider based on the first verification information and the second verification information, and execute a target service based on a verification result obtained through the service compliance verification.

The client can perform the service compliance verification on the third-party service provider based on the first verification information and the second verification information. If the first verification information matches the second verification information, it indicates that the third-party service provider has validity and authenticity. In this case, verification on the third-party service provider succeeds. If the first verification information does not match the second verification information, verification on the third-party service provider fails. In this case, an interception measure can be performed on the third-party service provider. For example, access to the third-party page is prohibited or a connection is interrupted.

When a hash value corresponding to the first verification information is the same as a hash value corresponding to the second verification information, the client can determine that the first verification information matches the second verification information.

Certainly, in addition to verifying the third-party service provider based on the first verification information and the second verification information, the client can further verify a domain name of the third-party service provider, and complete the service compliance verification on the third-party service provider after determining that the domain name of the third-party service provider is a trusted domain name.

In addition, the client may not store the first verification information, the second private key, and the second verification information in the secure environment of the terminal device, but store the first verification information, the second private key, and the second verification information in a specified environment such as a memory of the terminal device, and then verify the third-party service provider in the memory.

Further, the client can encrypt a predetermined communication key by using the second private key pre-stored in the local secure environment, to obtain an encrypted communication key, and then send the encrypted communication key to the third-party service provider. The communication key is used to encrypt communication data between the client and the third-party service provider.

When sending the digital certificate to the client, the third-party service provider can create a random number (a first random number) and send the random number to the client. After determining that verification on the third-party client succeeds, the client can create another random number (a second random number), and then the client can generate a communication key based on the first random number and the second random number.

After receiving the encrypted communication key, the third-party service provider can decrypt the encrypted communication key by using the pre-stored second public key, to obtain the decrypted communication key. Then, the third-party service provider can encrypt, based on the communication key, service data generated in a subsequent service execution process, and return encrypted service data to the client.

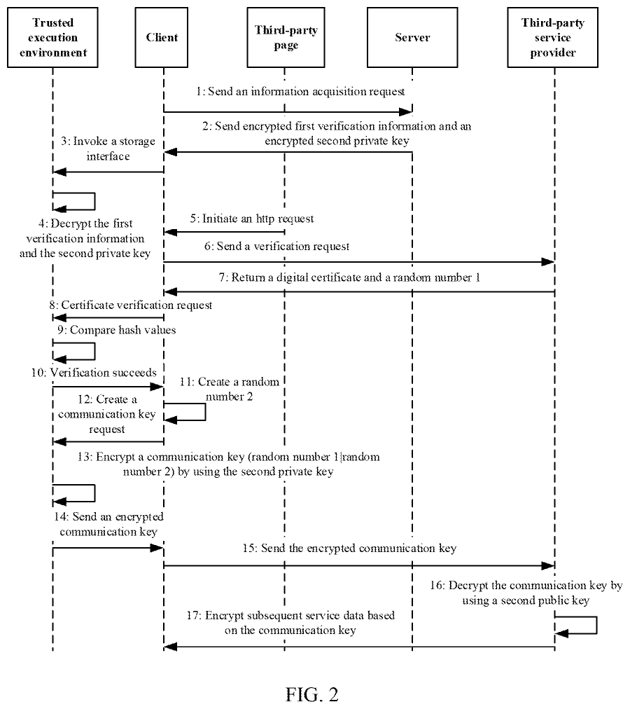

The client can decrypt the encrypted service data by using the locally stored communication key. Certainly, the client can also encrypt the service data in a same manner and return the encrypted service data to the third-party service provider. For ease of understanding, the present specification provides a schematic diagram of a verification process between a client and a third-party service provider, as shown in FIG. 2.

FIG. 2 is a schematic diagram illustrating a verification process between a client and a third-party service provider according to the present specification.

When a user accesses a third-party page, the client can send an information acquisition request for the third-party service provider to a server. After receiving the information acquisition request, the server sends an encrypted hash value (first verification information) of a digital certificate of the third-party service provider and an encrypted second private key to the client.

Then, the client invokes a storage interface of a TEE on a terminal device to decrypt the first verification information and the second private key. When the third-party page initiates an http request to the client, the client sends a verification request to the third-party service provider, and after receiving the verification request, the third-party service provider returns the digital certificate of the third-party service provider and a first random number to the client.

After receiving the digital certificate sent by the third-party service provider, the client calculates a hash value (second verification information) corresponding to the digital certificate and compares the hash value with the first verification information. If the hash value is consistent with the first verification information, verification on the third-party service provider succeeds. In this case, the client creates a second random number, generates a communication key based on the first random number and the second random number, encrypts the communication key by using the second private key, and sends an encrypted communication key to the third-party service provider.

The third-party service provider decrypts the encrypted communication key by using a second public key, and if the original communication key is obtained through decryption, encrypts subsequent service data based on the communication key.

In an actual service execution process, some important data, for example, information such as an account, a password, and a user identity that involve user privacy or property security, usually is obtained for a service executed by the third-party service provider. The third-party service provider can further verify a data source when obtaining the important data, to ensure data reliability.

For example, the third-party service provider can send a data acquisition request for specified data to the client by using the third-party page.

After receiving the data acquisition request, the client can calculate a hash value of the first verification information and a hash value of the second private key, use the hash value of the first verification information and the hash value of the second private key as third verification information, and send the specified data and the third verification information to the third-party service provider.

The third-party service provider can calculate a hash value of the digital certificate of the third-party service provider and a hash value of the second public key, use the hash value of the digital certificate of the third-party service provider and the hash value of the second public key as fourth verification information, and then determine whether the third verification information matches the fourth verification information. If yes, it indicates that a data source is the client, and obtained specified data is trusted data. In this case, the third-party service provider can execute a subsequent service based on the obtained specified data.

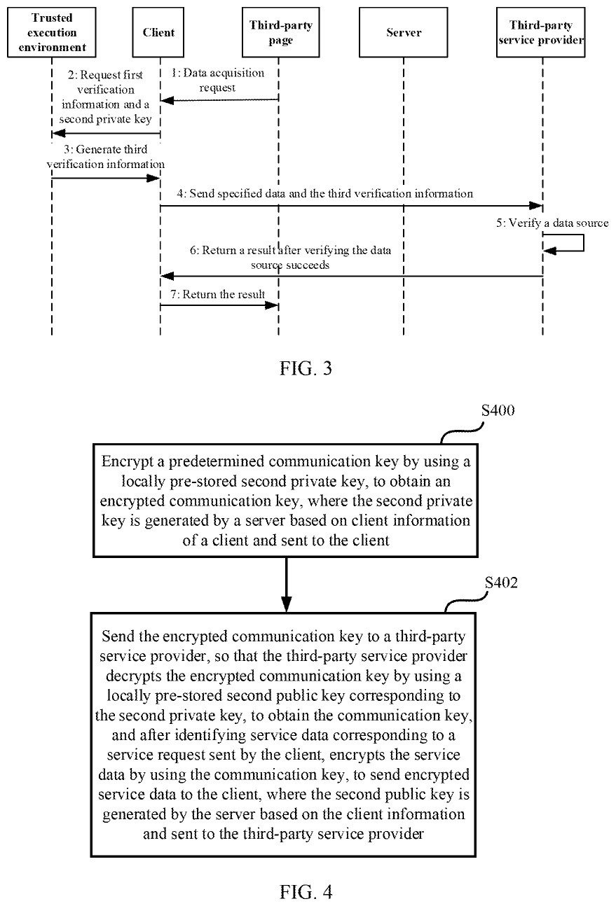

For ease of understanding, the present specification provides a schematic diagram of a process in which a third-party service provider verifies a data source, as shown in FIG. 3.

FIG. 3 is a schematic diagram illustrating a process in which a third-party service provider verifies a data source according to the present specification.

The third-party service provider can send a data acquisition request to a client by using a third-party page. After receiving the data acquisition request, the client can request first verification information (a hash value of a digital certificate) and a second private key from a TEE of a terminal device. The client can calculate a hash value of the first verification information and a hash value of the second private key in the TEE to obtain third verification information, and send the third verification information to the third-party service provider.

The third-party service provider calculates a hash value of a digital certificate of the third-party service provider and a hash value of a pre-stored second public key, uses the hash value of the digital certificate of the third-party service provider and the hash value of the pre-stored second public key as fourth verification information, and determines whether the third verification information matches the fourth verification information. If the third verification information matches the fourth verification information, verification on the client succeeds, the third-party service provider returns a verification success result to the client, and the client returns a verification result to the third-party page, so that the third-party service provider executes a subsequent service based on obtained specified data.

It should be noted that the above verification process between the client and the third-party service provider and the above process in which the third-party service provider verifies the data source can be services in different service scenarios. In this case, the client can re-obtain the first verification information of the third-party service provider from the server.

The above describes, from the perspective of the client, the service execution method provided in the present specification. For ease of understanding, the following describes, from the perspective of a third-party service provider, a service execution method provided in the present specification, as shown in FIG. 4.

FIG. 4 is a schematic flowchart illustrating a service execution method according to the present specification. The method includes step S400 and step S402.

S400: Encrypt a predetermined communication key by using a locally pre-stored second private key, to obtain an encrypted communication key, where the second private key is generated by the server based on client information of the client and sent to the client.

S402: Send the encrypted communication key to the third-party service provider, so that the third-party service provider decrypts the encrypted communication key by using a locally pre-stored second public key corresponding to the second private key, to obtain the communication key, and after identifying service data corresponding to a service request sent by the client, encrypts the service data by using the communication key, to send encrypted service data to the client, where the second public key is generated by the server based on the client information and sent to the third-party service provider.

It can be learned from the above method that, in this solution, a certificate identity of the third-party service provider can be strictly verified, and the third-party platform can strictly verify a client identity, which are necessary for transaction security. Storing a confidential hash value in a TEE can effectively prevent an attack from an intermediate person and avoid a risk such as a false transaction.

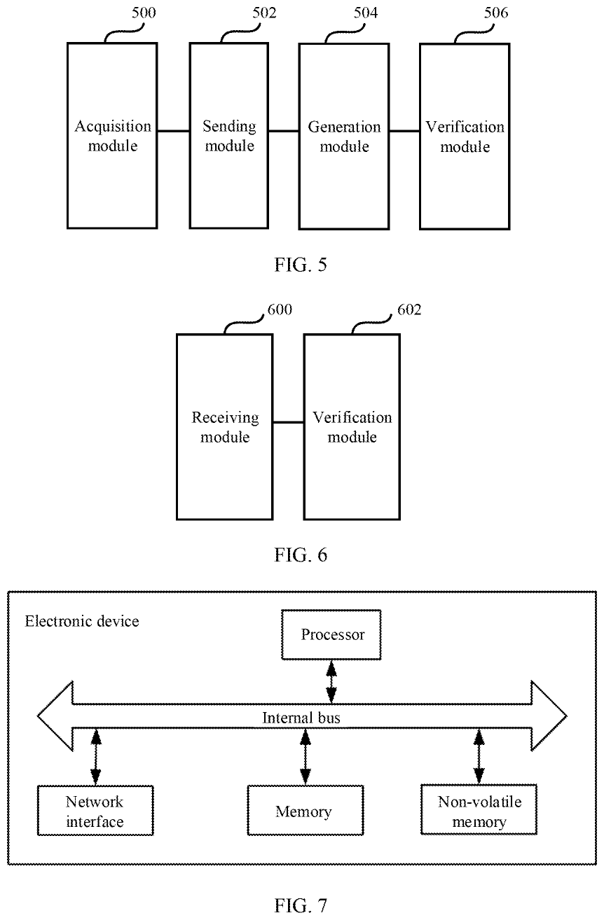

The above describes the service execution method in one or more implementations of the present specification. Based on the same idea, the present specification further provides a corresponding service execution apparatus, as shown in FIG. 5 or FIG. 6.

FIG. 5 is a schematic diagram of a service execution apparatus according to the present specification. The apparatus includes: an acquisition module 500, configured to send an information acquisition request for a third-party service provider to a server corresponding to a client, so that the server sends pre-stored first verification information corresponding to the third-party service provider to the client based on the information acquisition request, the first verification information being generated by the server based on a digital certificate of the third-party service provider after a trust relationship is established between a service party corresponding to the server and the third-party service provider; a sending module 502, configured to send, to the third-party service provider, a verification request used to verify service compliance of the third-party service provider, so that the third-party service provider sends the digital certificate of the third-party service provider to the client based on the verification request; a generation module 504, configured to generate second verification information corresponding to the third-party service provider based on the received digital certificate; and a verification module 506, configured to: perform service compliance verification on the third-party service provider based on the first verification information and the second verification information, and execute a target service based on a verification result obtained through the service compliance verification.

For example, before service compliance verification is performed on the third-party service provider based on the first verification information and the second verification information, the acquisition module 500 is further configured to store the obtained first verification information in a secure environment provided on a terminal device on which the client is installed, where the secure environment includes a trusted execution environment (TEE); the generation module 504 is specifically configured to transmit the received digital certificate to the secure environment, to generate the second verification information corresponding to the third-party service provider in the secure environment; and the verification module 506 is specifically configured to perform the service compliance verification on the third-party service provider based on the first verification information and the second verification information in the secure environment.

For example, the sending module 502 is specifically configured to: send the information acquisition request to the server, so that the server encrypts the first verification information by using a predetermined first public key, to obtain encrypted first verification information; and decrypt the encrypted first verification information by using a first private key pre-stored on a terminal device on which the client is installed, to obtain the first verification information.

For example, the verification module 506 is specifically configured to: encrypt a predetermined communication key by using a locally pre-stored second private key, to obtain an encrypted communication key, where the second private key is generated by the server based on client information of the client and sent to the client; and send the encrypted communication key to the third-party service provider, so that the third-party service provider decrypts the encrypted communication key by using a locally pre-stored second public key corresponding to the second private key, to obtain the communication key, and after identifying service data corresponding to a service request sent by the client, encrypts the service data by using the communication key, to send encrypted service data to the client, where the second public key is generated by the server based on the client information and sent to the third-party service provider.

For example, the verification module 506 is further configured to: receive a data acquisition request sent by the third-party service provider for specified data; generate third verification information based on the first verification information obtained and a locally pre-stored second private key, where the second private key is generated by the server based on client information of the client and sent to the client; and send the third verification information and the specified data to the third-party service provider, so that the third-party service provider generates fourth verification information based on a received second public key and a digital certificate locally pre-stored at the third-party service provider, verifies a data source of the specified data based on the third verification information and the fourth verification information, and executes a service based on the specified data after verifying the data source succeeds, where the second public key is generated by the server based on the client information and sent to the third-party service provider.

FIG. 6 is a schematic diagram of a service execution apparatus according to the present specification. The apparatus includes: a receiving module 600, configured to receive, by a third-party service provider, a verification request sent by a client to verify service compliance of the third-party service provider, the verification request being sent by the client to the third-party service provider after receiving first verification information corresponding to the third-party service provider, the first verification information being sent by a server corresponding to the client to the client after receiving an information acquisition request sent by the client, and the first verification information being generated by the server based on a digital certificate of the third-party service provider after a trust relationship is established between a service party corresponding to the server and the third-party service provider; and a verification module 602, configured to send the digital certificate of the third-party service provider to the client based on the verification request, so that the client generates second verification information corresponding to the third-party service provider based on the received digital certificate, verifies the third-party service provider based on the first verification information and the second verification information, and executes a target service based on a verification result obtained through the service compliance verification.

For example, the verification module 602 is further configured to: send a data acquisition request for specified data to the client, so that the client generates third verification information based on the first verification information obtained and a locally pre-stored second private key, and sends the third verification information and the specified data to the third-party service provider, where the second private key is generated by the server based on client information of the client and sent to the client; generate fourth verification information based on a received second public key and a digital certificate locally pre-stored at the third-party service provider, where the second public key is generated by the server based on the client information and sent to the third-party service provider; and verify a data source of the specified data based on the third verification information and the fourth verification information, and execute a service based on the specified data after verifying the data source succeeds.

The present specification further provides a computer-readable storage medium. The storage medium stores a computer program, and the computer program can be used to perform the service execution method provided in FIG. 1 or FIG. 4.

The present specification further provides a schematic diagram illustrating a structure of an electronic device corresponding to FIG. 1 or FIG. 4 shown in FIG. 7. As shown in FIG. 7, at a hardware layer, the electronic device includes a processor, an internal bus, a network interface, a memory, and a non-volatile memory, and certainly can further include hardware required by another service. The processor reads a corresponding computer program from the non-volatile memory to the memory and then runs the computer program, to implement the service execution method described in FIG. 1 or FIG. 4. Certainly, in addition to a software implementation, the present specification does not exclude other implementations, such as a logic device or a combination of software and hardware. In other words, an execution entity of the following processing flow is not limited to each logic unit, but can also be hardware or logic devices.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code may be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively and/or additionally, the apparatus configured to implement various functions can even be considered as both a software module implementing the method and a structure in the hardware component.

Systems, apparatuses, modules, or units that are described in the above implementations can be for example implemented by using a computer chip or an entity, or by using a product with a certain function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various units. Certainly, when the present specification is implemented, a function of each unit can be implemented in one or more pieces of software and/or hardware.

A person skilled in the art should understand that the implementations of the present specification can be provided as methods, systems, or computer program products. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the methods, the devices (systems), and the computer program products based on the implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a function in one or more processes in the flowcharts and/or in one or more blocks in the block diagrams.

Alternatively and/or additionally, these computer program instructions can be stored in a computer-readable storage that can instruct a computer or another programmable data processing device to work in a manner, so the instructions stored in the computer-readable storage generate an artifact that includes an instruction apparatus. The instruction apparatus implements a function in one or more procedures in the flowcharts and/or in one or more blocks in the block diagrams.

Alternatively and/or additionally, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a function in one or more procedures in the flowcharts and/or in one or more blocks in the block diagrams.

In a typical configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

A person skilled in the art should understand that the implementations of the present specification can be provided as a method, a system, or a computer program product. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification can be described in the general context of computer-executable instructions executed by a computer, for example, a program module. Generally, the program module includes a routine, a program, an object, a component, a data structure, etc. executing a task or implementing a data type. The present specification can alternatively and/or additionally be practiced in distributed computing environments in which tasks are performed by remote processing devices that are connected through a communication network. In the distributed computing environments, the program module can be located in local and remote computer storage media including storage devices.

The implementations of the present specification are described in a progressive manner. For same or similar parts of the implementations, mutual references can be made to the implementations. Each implementation focuses on a difference from the other implementations. Particularly, the system implementations are basically similar to the method implementations, and therefore are described briefly. For related parts, references can be made to some descriptions of the method implementations.

The above-mentioned descriptions are merely some implementations of the present specification, and are not intended to limit the present specification. A person skilled in the art can make various variations and changes to the present specification. Any modification, equivalent replacement, and improvement made in the spirit and principle of the present specification shall fall within the scope of the present specification including the claims.

1. A method, comprising:
receiving, by a client and from a server, first verification information corresponding to a third-party entity, the first verification information being generated by the server based on a digital certificate of the third-party entity;
receiving, by the client and from the third-party entity, the digital certificate of the third-party entity;
generating second verification information corresponding to the third-party entity based on the digital certificate received by the client;
performing verification on the third-party entity based on the first verification information and the second verification information; and
executing a target action based on a verification result obtained through the verification.

2. The method according to claim 1, further comprising:
before the performing the verification on the third-party entity based on the first verification information and the second verification information,
storing the first verification information in a secure environment on a terminal device on which the client is installed, wherein the secure environment includes a trusted execution environment (TEE),
wherein:
the generating the second verification information corresponding to the third-party entity based on the received digital certificate includes:
transmitting the received digital certificate to the secure environment, and
generating the second verification information corresponding to the third-party entity in the secure environment; and
the performing the verification on the third-party entity based on the first verification information and the second verification information includes:
performing the verification on the third-party entity based on the first verification information and the second verification information in the secure environment.

3. The method according to claim 1, wherein the receiving the digital certificate of the third-party entity includes:
sending an information acquisition request to the server for the server to encrypt the first verification information by using a first public key to obtain encrypted first verification information; and
decrypting the encrypted first verification information by using a first private key stored on a terminal device on which the client is installed, to obtain the first verification information.

4. The method according to claim 1, wherein the executing the target action based on the verification result obtained through the verification comprises:
encrypting a communication key by using a second private key, to obtain an encrypted communication key, wherein the second private key is generated by the server based on client information of the client and sent to the client; and
sending the encrypted communication key to the third-party entity, for the third-party entity to decrypt the encrypted communication key by using a second public key corresponding to the second private key to obtain the communication key, and after identifying service data corresponding to a service request sent by the client, to encrypt the service data by using the communication key, and to send encrypted service data to the client, wherein the second public key is generated by the server based on the client information and sent to the third-party entity.

5. The method according to claim 1, further comprising:
receiving a data acquisition request sent by the third-party entity for data;
generating third verification information based on the first verification information obtained and a second private key, wherein the second private key is generated by the server based on client information of the client and sent to the client; and
sending the third verification information and the data to the third-party entity, for the third-party entity to generate fourth verification information based on a second public key and the digital certificate, and verify a data source of the data based on the third verification information and the fourth verification information, wherein the second public key is generated by the server based on the client information and sent to the third-party,
wherein the executing the target action includes executing the target action based on the data after the verifying the data source succeeds.

6. The method according to claim 1, wherein the receiving the digital certificate of the third-party entity comprising:
sending a verification request, by the client to verify service compliance of the third-party entity, the verification request being sent after receiving the first verification information, and the first verification information being generated by the server based on a digital certificate of the third-party entity after a trust relationship is established between a service party corresponding to the server and the third-party entity.

7. A computing system, comprising:
one or more processors; and
one or more memory devices, individually or collectively, having computer executable instructions stored thereon, the computer executable instructions, when executed by the one or more processors, enabling the one or more processors to, individually or collectively, implement acts including:
receiving, by a client and from a server, first verification information corresponding to a third-party entity, the first verification information being generated by the server based on a digital certificate of the third-party entity;
receiving, by the client and from the third-party entity, the digital certificate of the third-party entity;
generating second verification information corresponding to the third-party entity based on the digital certificate received by the client;
performing verification on the third-party entity based on the first verification information and the second verification information; and
executing a target action based on a verification result obtained through the verification.

8. The computing system according to claim 7, wherein the acts include:
before the performing the verification on the third-party entity based on the first verification information and the second verification information,
storing the first verification information in a secure environment on a terminal device on which the client is installed, wherein the secure environment includes a trusted execution environment (TEE),
wherein:
the generating the second verification information corresponding to the third-party entity based on the received digital certificate includes:
transmitting the received digital certificate to the secure environment, and
generating the second verification information corresponding to the third-party entity in the secure environment; and
the performing the verification on the third-party entity based on the first verification information and the second verification information includes:
performing the verification on the third-party entity based on the first verification information and the second verification information in the secure environment.

9. The computing system according to claim 7, wherein the receiving the digital certificate of the third-party entity includes:
sending an information acquisition request to the server for the server to encrypt the first verification information by using a first public key to obtain encrypted first verification information; and
decrypting the encrypted first verification information by using a first private key stored on a terminal device on which the client is installed, to obtain the first verification information.

10. The computing system according to claim 7, wherein the executing the target action based on the verification result obtained through the verification comprises:
encrypting a communication key by using a second private key, to obtain an encrypted communication key, wherein the second private key is generated by the server based on client information of the client and sent to the client; and
sending the encrypted communication key to the third-party entity, for the third-party entity to decrypt the encrypted communication key by using a second public key corresponding to the second private key to obtain the communication key, and after identifying service data corresponding to a service request sent by the client, to encrypt the service data by using the communication key, and to send encrypted service data to the client, wherein the second public key is generated by the server based on the client information and sent to the third-party entity.

11. The computing system according to claim 7, wherein the acts include:
receiving a data acquisition request sent by the third-party entity for data;
generating third verification information based on the first verification information obtained and a second private key, wherein the second private key is generated by the server based on client information of the client and sent to the client; and
sending the third verification information and the data to the third-party entity, for the third-party entity to generate fourth verification information based on a second public key and the digital certificate, and verify a data source of the data based on the third verification information and the fourth verification information, wherein the second public key is generated by the server based on the client information and sent to the third-party,
wherein the executing the target action includes executing the target action based on the data after the verifying the data source succeeds.

12. The computing system according to claim 7, wherein the receiving the digital certificate of the third-party entity comprising:
sending a verification request, by the client to verify service compliance of the third-party entity, the verification request being sent after receiving the first verification information, and the first verification information being generated by the server based on a digital certificate of the third-party entity after a trust relationship is established between a service party corresponding to the server and the third-party entity.

13. A non-transitory storage medium having computer executable instructions stored thereon, the computer executable instructions, when executed by one or more processors, enabling the one or more processors to, individually or collectively, implement acts comprising:
receiving, by a client and from a server, first verification information corresponding to a third-party entity, the first verification information being generated by the server based on a digital certificate of the third-party entity;
receiving, by the client and from the third-party entity, the digital certificate of the third-party entity;
generating second verification information corresponding to the third-party entity based on the digital certificate received by the client;
performing verification on the third-party entity based on the first verification information and the second verification information; and
executing a target action based on a verification result obtained through the verification.

14. The non-transitory storage medium according to claim 13, wherein the acts include:
before the performing the verification on the third-party entity based on the first verification information and the second verification information,
storing the first verification information in a secure environment on a terminal device on which the client is installed, wherein the secure environment includes a trusted execution environment (TEE),
wherein:
the generating the second verification information corresponding to the third-party entity based on the received digital certificate includes:
transmitting the received digital certificate to the secure environment, and
generating the second verification information corresponding to the third-party entity in the secure environment; and
the performing the verification on the third-party entity based on the first verification information and the second verification information includes:
performing the verification on the third-party entity based on the first verification information and the second verification information in the secure environment.

15. The non-transitory storage medium according to claim 13, wherein the receiving the digital certificate of the third-party entity includes:
sending an information acquisition request to the server for the server to encrypt the first verification information by using a first public key to obtain encrypted first verification information; and
decrypting the encrypted first verification information by using a first private key stored on a terminal device on which the client is installed, to obtain the first verification information.

16. The non-transitory storage medium according to claim 13, wherein the executing the target action based on the verification result obtained through the verification comprises:
encrypting a communication key by using a second private key, to obtain an encrypted communication key, wherein the second private key is generated by the server based on client information of the client and sent to the client; and
sending the encrypted communication key to the third-party entity, for the third-party entity to decrypt the encrypted communication key by using a second public key corresponding to the second private key to obtain the communication key, and after identifying service data corresponding to a service request sent by the client, to encrypt the service data by using the communication key, and to send encrypted service data to the client, wherein the second public key is generated by the server based on the client information and sent to the third-party entity.

17. The non-transitory storage medium according to claim 13 wherein the acts include:
receiving a data acquisition request sent by the third-party entity for data;
generating third verification information based on the first verification information obtained and a second private key, wherein the second private key is generated by the server based on client information of the client and sent to the client; and
sending the third verification information and the data to the third-party entity, for the third-party entity to generate fourth verification information based on a second public key and the digital certificate, and verify a data source of the data based on the third verification information and the fourth verification information, wherein the second public key is generated by the server based on the client information and sent to the third-party,
wherein the executing the target action includes executing the target action based on the data after the verifying the data source succeeds.

18. The non-transitory storage medium according to claim 13, wherein the receiving the digital certificate of the third-party entity comprising:
sending a verification request, by the client to verify service compliance of the third-party entity, the verification request being sent after receiving the first verification information, and the first verification information being generated by the server based on a digital certificate of the third-party entity after a trust relationship is established between a service party corresponding to the server and the third-party entity.

19. A method, comprising:
receiving, by a third-party entity, a verification request sent by a client to verify service compliance of the third-party service provider, the verification request being sent by the client to the third-party service provider after receiving first verification information corresponding to the third-party entity, the first verification information being sent by a server corresponding to the client to the client after receiving an information acquisition request sent by the client, and the first verification information being generated by the server based on a digital certificate of the third-party entity after a trust relationship is established between a service party corresponding to the server and the third-party entity; and
sending the digital certificate of the third-party entity to the client based on the verification request, for the client to generate second verification information corresponding to the third-party entity based on the received digital certificate, verify the third-party entity based on the first verification information and the second verification information, and execute a target action based on a verification result of the verifying the third-party entity.

20. The method according to claim 19, further comprising:
sending a data acquisition request for data to the client, for the client to generate third verification information based on the first verification information obtained and a second private key, and send the third verification information and the data to the third-party entity, wherein the second private key is generated by the server based on client information of the client and sent to the client;
generating fourth verification information based on a received second public key and the digital certificate locally stored at the third-party entity, wherein the second public key is generated by the server based on the client information and sent to the third-party entity;
verifying a data source of the data based on the third verification information and the fourth verification information; and
executing a target act based on the data after the verifying the data source succeeds.
